(19) United States
(12) Patent Application Publication
(10) Pub. No.: US 2024/0265347 A1
(43) Pub. Date: Aug. 8, 2024

(54) BLOCKCHAIN-BASED RANKING AND SELECTION OF CREATIVE SUBMISSIONS

(71) Applicants: Leo MATCHETT, Los Angeles, CA (US); Michael MUSANTE, Los Angeles, CA (US); Roman COPPOLA, Los Angeles, CA (US)

(72) Inventors: Leo Matchett, Los Angeles, CA (US); Michael Musante, Los Angeles, CA (US); Roman Coppola, Los Angeles, CA (US)

(21) Appl. No.: 18/578,655

(22) PCT Filed: Jul. 12, 2022
(86) PCT No.: PCT/US2022/036844

§ 371 Date: Jan. 11, 2024

Related U.S. Application Data
(60) Provisional application No. 63/220,908, filed on Jul. 12, 2021.

(51) Int. Cl. G06Q 10/10; G06Q 30/0279; G06Q 30/0282

(52) U.S. Cl. CPC G06Q 10/103; G06Q 30/0279; G06Q 30/0282; G06Q 2220/00

(57) ABSTRACT

Aspects described herein may allow for receiving, from a device in communication with a blockchain, a content proposal stored on the blockchain; providing, to a plurality of user devices, the content proposal; receiving, from the device, information indicating a user rating generated by a first user device of the plurality of user devices and stored on the blockchain via a smart contract associated with the content proposal, and a stake comprising one or more blockchain credits associated with the user rating; and ranking a plurality of content proposals comprising the content proposal, wherein a rank of the content proposal is based on the user rating and the stake for the user rating.

### PRIORITY CLAIM

The present disclosure claims priority to, and hereby incorporates by reference in its entirety, U.S. Provisional Application No. 63/220,908, filed on Jul. 12, 2021.

### BACKGROUND

Many industries are difficult to break into. In the case of the film industry, for example, major studio films are typically made with known talent, directors, and writers. Yet, despite this challenge, artists with diverse backgrounds throughout the world continue to pursue “independent” filmmaking and aspire to beat the odds. Many of these projects do not attract the attention of a major film studio and, without adequate resources, fail to make it to production. Moreover, production costs for films have grown exponentially over the past few decades. This makes it very difficult for self-financed films to compete with those that obtain studio financing.

Other industries (e.g., the music industry or the software industry, as two examples) face similar problems in identifying and supporting creators, as well as connecting creators with networks, funders, and other resources.

Techniques, systems, methods, and other aspects described herein address these and other problems.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding systems and computer-readable media are also within the scope of the disclosure.

Some aspects described herein may provide a computer-implemented method for receiving, from a device in communication with a blockchain, a content proposal stored on the blockchain; providing, to a plurality of user devices, the content proposal; receiving, from the device, information indicating: a user rating generated by a first user device of the plurality of user devices and stored on the blockchain via a smart contract associated with the content proposal; and a stake comprising one or more blockchain credits associated with the user rating; and ranking a plurality of content proposals comprising the content proposal, wherein a rank of the content proposal is based on the user rating and the stake for the user rating.

In embodiments, the method may further comprise, prior to the providing, receiving, from a second user device of the plurality of user devices, a moderation of the content proposal; determining that the second user device is associated with reputation score above a threshold reputation score; and based on the moderation and the determination, allowing the content proposal to be provided to the plurality of user devices.

In embodiments, the content proposal further comprises a bounty, wherein a second smart contract is configured to distribute at least a portion of the bounty to the first user device in exchange for the user rating. Additionally or alternatively, the user rating comprises one or more sub-ratings. In embodiments, the rank of the content proposal is further based on a reputation score associated with the user rating.

In embodiments, the method further comprises receiving a review of the user rating, wherein the rank of the content proposal is based on the received review of the user rating.

In embodiments, the method further comprises receiving a review of the content proposal from a second user device; receiving one or more likes and one or more dislikes of the review; and ranking the review of the content proposal based on the one or more likes and one or more dislikes of the review, wherein the rank of the content proposal is based on the rank of the review.

In embodiments, a system may be provided comprising a server platform; and a user device storing an application configured to perform steps comprising: generating a content proposal comprising one or more of textual information, video information, or image information; causing generation of a block on a blockchain comprising: data representing the content proposal; and a transfer of one or more tokens associated with the content proposal to a smart contract; wherein the server platform is configured to perform steps comprising: receiving, from a blockchain node, the content proposal; providing, to a plurality of user devices, the content proposal: receiving, from the blockchain node, information indicating: a user rating stored on the blockchain via a second smart contract associated with the content proposal; and a stake comprising one or more blockchain credits associated with the user rating; and ranking a plurality of content proposals comprising the content proposal, wherein a rank of the content proposal is based on the user rating and the stake for the user rating.

In embodiments, the server platform is further configured to perform steps comprising: prior to the providing, receiving a moderation of the content proposal; determining that the moderation is associated with reputation score above a threshold reputation score; and based on the moderation and the determination, allowing the content proposal to be provided to the plurality of user devices.

In embodiments, the content proposal further comprises a bounty, wherein the smart contract is configured to distribute at least a portion of the bounty in exchange for the user rating. Additionally or alternatively, the user rating comprises one or more sub-ratings. In embodiments, the rank of the content proposal is further based on a reputation score associated with the user rating.

In embodiments, the server platform is further configured to perform steps comprising receiving a review of the user rating, wherein the rank of the content proposal is based on the received review of the user rating.

In embodiments, the server platform is further configured to perform steps comprising: receiving a review of the content proposal from a second user device: receiving one or more likes and one or more dislikes of the review; and ranking the review of the content proposal based on the one or more likes and one or more dislikes of the review, wherein the rank of the content proposal is based on the rank of the review.

In embodiments, a method is provided comprising: generating, by a user device, a content proposal comprising one or more of textual information, video information, or image information: causing, by the user device, generation of a blockchain block comprising: data representing the content proposal; and a transfer of one or more tokens associated with the content proposal to a smart contract; receiving, by the user device, from a server platform, information indicating: at least one user rating of the content proposal; and for each of the least one user ratings, a corresponding stake comprising one or more tokens associated with the user rating; and receiving, by the user device, a list of ranked content proposals comprising the content proposal, wherein a rank of the content proposal is based on the at least one user rating and the corresponding stake for each of the at least one user ratings.

In embodiments, the method further comprises receiving, from the server platform, a reputation score for a user of the user device, wherein the reputation score is based on the rank of the content proposal; and displaying, by the user device, the reputation score.

In embodiments, the method further comprises, prior to the generating of the content proposal, receiving, by the user device, a plurality of tokens in exchange for answering a creative query.

In embodiments, the method further comprises receiving, from the server platform, an indication that another user has added tokens to the content proposal.

In embodiments, the user rating comprises one or more sub-ratings. Additionally or alternatively, the rank of the content proposal is further based on a reputation score associated with the user rating.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIGS. 1A-B show different views of an environment including one or more devices for implementing one or more aspects described herein;

FIG. 2 shows an example blockchain for implementing one or more aspects described herein;

FIGS. 3A-B show example smart contracts for implementing one or more aspects described herein;

FIG. 4 shows an example data flow for interacting with one or more smart contracts as described herein;

FIGS. 5A-C show a flow chart of an example process for carrying out one or more aspects described herein; and

FIG. 6 shows an example method for performing one or more aspects described herein.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein may relate to methods and techniques for ranking and selecting user-generated submissions. Blockchain-based methods (e.g., tokens, smart contracts, mining, etc.) may be adapted to provide an ecosystem in which user communities may develop, and in which user-generated submissions (e.g., proposals to develop content, goods, and/or services, creative queries, etc.) may be moderated, rated, reviewed, ranked, voted on, and selected for various reasons (e.g., to provide funding or other assistance).

In embodiments, blockchain-based techniques may be beneficially leveraged to provide mathematical methods of generating user reputation scores, which may be used to adjust an influence that a user of a community may have in engaging with community-generated content, such as submissions, proposals, queries, or other community content. For example, a mathematically-defined and cryptographically-verifiable reputation score may be used to influence how much weight may be given to a user's submissions, a user's moderation of other users' submissions, a user's ratings and/or reviews of other users' submissions, a user's votes on other users' submissions, and/or the like. By defining and/or storing the reputation score, and the inputs that are used to determine the reputation score, on a blockchain, techniques described herein technologically improve on prior voting, rating, review, and selection systems, in which, for example, votes, ratings, reviews, selections, and the like may not be weighted in optimal ways. For example, prior voting or ranking systems may inefficiently provide equal voting weights to all voters, which may not be appropriate for certain applications in which it may be desirable to assign additional weight based on expertise, experience, influence within an industry, and other relevant factors. Systems, methods, and other techniques described herein technologically improve on these prior systems at least by adjusting the weights assigned to various user votes, ratings, reviews, and the like based on variety of mathematically-defined and cryptographically-verifiable factors that may be relevant to the community-driven generation of content.

Additionally, techniques described herein may leverage token staking/locking to influence the weight provided to votes, ratings, reviews, and the like in a fair way (e.g., a mathematically-defined and cryptographically-verifiable way), while also balancing other factors (e.g., so that the users with the most tokens do not always have the most influence). By allowing a limited but defined weight increase due to staking, techniques described herein allow community users to provide the most influence on the decisions that matter most to each individual user. Additionally, because systems described herein may be configured such that blockchain tokens may only be staked to one particular usage at a time, users with many tokens cannot simultaneously influence everything that happens within a community. Accordingly, systems, methods, and other techniques described herein technologically improve on prior systems in which influence may be used in ill-defined and amorphous ways, by providing a limited and set amount of influence to holders of blockchain tokens.

Several other techniques described herein further innovate and improve on prior systems. For example, the use of token bounties and/or submission fees as described herein may provide incentives for community participation by providing pools of blockchain tokens that may be obtainable by interacting with user submissions according to rules that are publicly and cryptographically defined (e.g., by smart contracts stored on a blockchain). Accordingly, because blockchain tokens may be rare and valuable, users may have verifiable and valuable financial incentives to creatively contribute to a community and the community-driven content contained therein. These methods accordingly improve on prior systems in which users may have no financial incentive to contribute to community development, and/or in which any such incentives, to the extent they exist, are not trustable and automatic.

Additionally, techniques described herein provide an automatic and provable mechanism for storing community-driven content, which may facilitate proof of fixation for copyright or other purposes. Because proposal and/or query data as discussed herein may include creative works and/or hashes that cryptographically link to the creative works (e.g., if the creative data is stored off-chain), the owner/creator of the work may definitively prove that the creative work had been created and stored as of a particular date (e.g., the proposal submission date). In some embodiments, the benefits of this system may also be monetized to provide a paid service for a cryptographically provable registration of creative content using the submission techniques described herein.

Many techniques described herein, because they rely on community trust, verifiability, and the automatic interaction of various user inputs with various smart contracts and tokens, would not have been possible or effective using previous technologies. For example, without the novel use of reputation scores defined based on blockchain interactions, including the staking of blockchain tokens, the techniques for weighting votes, ratings, etc. as described herein would not be effective. Accordingly, the techniques described herein represent a technological advance to the state of the art.

These and other benefits of the techniques described herein will be apparent from the detailed description that follows. An ecosystem for implementing these techniques may comprise a decentralized, blockchain-based network that is designed to serve as a distributed ledger for a client application 121 and other similar applications. The client application 121 and other such apps launched on top of the blockchain offer an alternative to the traditional creative industry (e.g., film industry) submission, review, and financing processes. Through easy-to-use applications like the client application 121, users may be able to collaborate with one another to take creative projects from proposal to production.

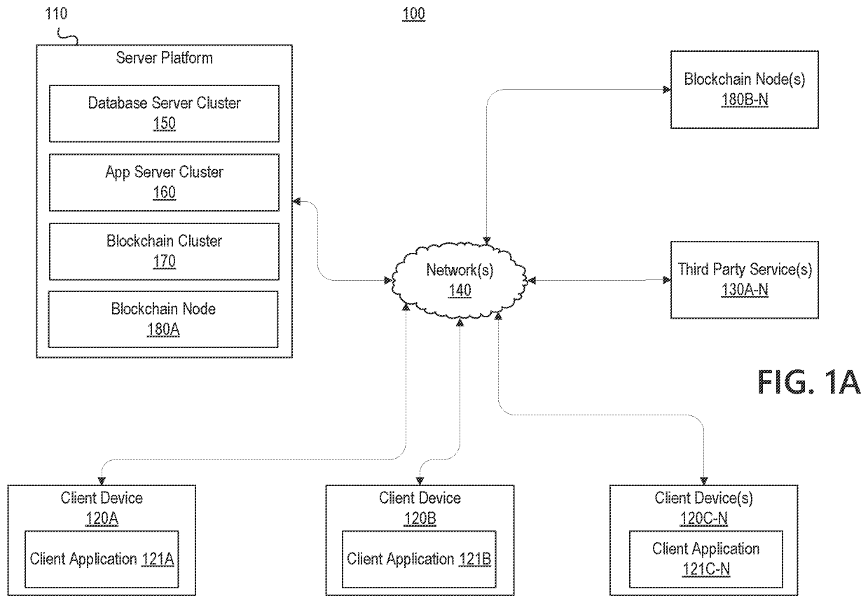

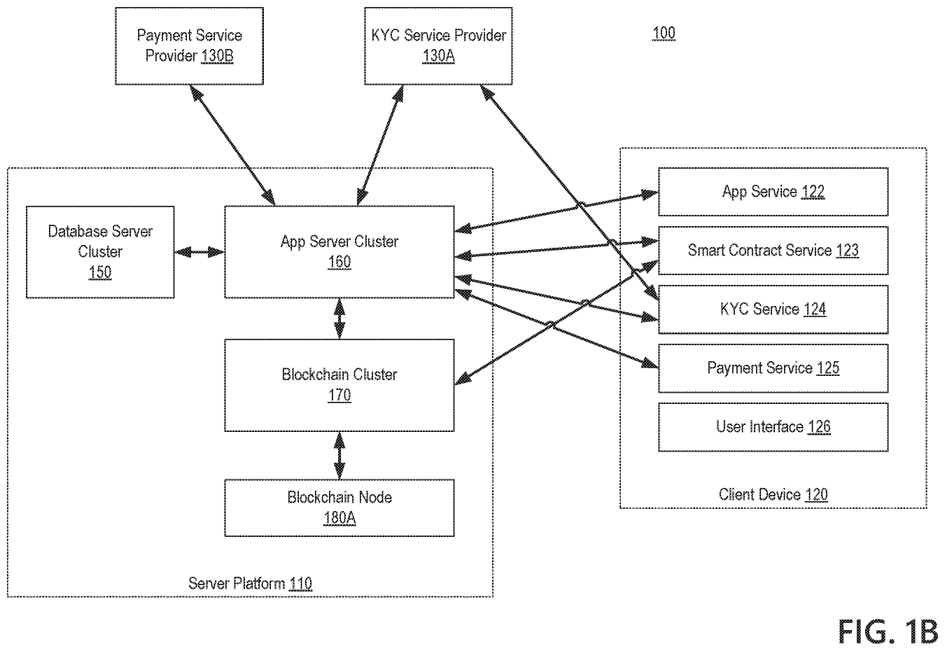

FIG. 1A shows a system 100 including components that carry out methods and operations as described in more detail below. The system 100 may include a plurality of devices that comprise a server platform 110, a plurality of client devices 120, one or more third party services 130, and one or more blockchain nodes 180, in communication via one or more networks 140. It will be appreciated that the network connections shown are illustrative and any means of establishing communications links between the various devices may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies.

The server platform 110 may itself include a plurality of devices, including a database server cluster 150, an app server cluster 160, a blockchain cluster 170, and a blockchain node 180A. In general, the server platform 110 may provide functionality in support of a client application 121 that allows users to submit, moderate, review, and otherwise interact with content such as user-generated media content. For example, a database server cluster 150 may be configured to read, write, store, and modify various data that may be used for providing the client application 121. Such data may include data that may be written to and/or read from a blockchain, data about users, data about proposed content, data about proposals to create and/or develop user-generated media content or other content, and/or other data that may be used for the client application 121. The app server cluster 160 may provide various functionality for the client application 121, including generating data that it may to provide services for the client application 121, generating data that one or more client devices 120 may use for the client application 121, coordinating with third-party services 130 as necessary for the client application 121, instructing the database server cluster 150 and/or blockchain cluster 170 to perform various functions for the client application 121, and/or performing other such functions for the client application 121. The blockchain cluster 170 may provide various functions related to using a blockchain to store transactions, proposals, contracts, and other such data for the client application 121, including causing such data to be read from and/or written to a blockchain, generating smart contracts for the blockchain, causing interactions with smart contracts on the blockchain, and/or other such functions. The blockchain node 180A may provide services for interfacing with other blockchain nodes 180 in order to provide functions for the client application 121, including generating and/or mining blocks for the blockchain, generating transactions to be written to the blockchain, storing and/or retrieving data to/from the blockchain, and/or performing other such blockchain functionalities. These functions, and additional functions of each of the components of the server platform 110, are described in more detail below.

Client devices 120 may be user devices used by various users to interact with the client application 121. For example, one user may use a client device 120A to submit a proposal to create user-generated media content via the client application 121, another user may use another client device 120B to moderate and/or review the proposal via the client application 121, another user may use another client device 120C to leave commentary and/or otherwise contribute to the proposal via the client application 121, another user may use another client device 120D to view a list of currently-pending proposals via the client application 121, and the like. The client devices may include mobile devices (e.g., smartphones, laptops, tablets), wearable devices (e.g., smartwatches), computing devices (e.g., desktop computers, servers), and/or any other devices that may run and interact with the client application 121.

In embodiments, a cluster as described herein may include one or more computing devices. The computing device(s) making up the cluster may execute the methods and tasks described herein using serial, parallel, or other computing techniques. For example, a first computing device may distribute sub-tasks of a task to various computing devices of the clusters (e.g., when the sub-tasks are parallelizable), may balance workloads between the computing devices, and the like. Thus, although a cluster may be described as a single entity, the cluster may use a plurality of computing devices working in coordination to complete the tasks described herein.

Third-party services 130 may include any services that may be used to support operations of the client application 121. For example, a first third-party service 130A may be a know-your-customer (KYC) service provider, which may be used to verify a user's identity before the user is allowed to create an account for use with the client application 121. As another example, a second third-party service 130B may include a payment service provider that is used to process user-submitted payments for use in the client application 121. The third-party services 130 may include servers that provide APIs usable by the server platform 110 and/or client devices 120, as described in more detail below.

Client devices (e.g., mobile device 107, computing device 109) may be user devices that may send queries or other requests for information about merchants to the search system 101 as described herein. The third party data system(s) may include databases of information that may be accessed by the search system 101 as described herein. Databases may include, but are not limited to relational databases, hierarchical databases, distributed databases, in-memory databases, flat file databases, XML databases, NoSQL databases, graph databases, and/or a combination thereof. The search system 101 may receive queries, identify one or more merchants matching the query, generate user-customized ratings for the one or more merchants, and return the user-customized ratings to the client devices as described herein. The network 103 may include a local area network (LAN), a wide area network (WAN), a wireless telecommunications network, and/or any other communication network or combination thereof.

FIG. 1B illustrates additional details about how various components of the system 100 may connect and interact with each other in order to provide services to the client application 121. FIG. 1B again shows that the server platform 110 includes various components (e.g., devices or groups of devices) such as the database server cluster 150, app server cluster 160, blockchain cluster 170, and blockchain node 180A, which are briefly overviewed above with respect to FIG. 1A. These various components may interact with components of the client application 121 stored on the client device 120, including an app service 122, a smart contract service 123, a KYC service 124, a payment service 125, and a user interface 126. Briefly, each of these components of the client application 121 stored on the client application provide various functionalities for the client application 121. For example, an app service 122 may provide functions such as interacting with the app server cluster 160 to submit and receive data (e.g., proposals, reviews, etc.) to the server platform 110, a smart contract service 123 may provide functions that interact with app server cluster 160 and/or blockchain cluster 170 to cause the blockchain node 180 to read, write, and/or store data on the blockchain, a KYC service 124 may provide functions for interacting with the app server cluster 160 and/or KYC service provider 130A to cause verification of a user's identity, payment service 125 may interact with the app server cluster 160 to cause payments to be submitted and/or processed via payment service provider 130B, and a user interface 126 may cause the client device 120 to output data to a user and to receive user inputs.

Each of the components 122-126 may be modules of the client application 121. In one example, the components 122-126 are components of a native version of the client application 121 that may be downloaded (e.g., via an application store if the client device 120 is a smartphone) and executed on the client device 120. In another example, the components 122-126 may be downloaded from a web server, for example as Javascript code that may be executed by a browser application stored on the client device 120. Thus, different versions of the client application 121 may be obtained from different sources. Additionally, various client devices 120, which may use various operating systems, may use different versions of the client application 121. For example, a first client device 120A that is an iOS smartphone may use a version of the client application 121 configured for IOS, a second client device 120B that is a WINDOWS laptop may use a version of the client application 121 configured for MICROSOFT WINDOWS, and the like. In general, each of the various versions of the client application 121 may have equivalent or at least similar functionality, and therefore the various components may perform identical or similar functionalities for any version of the client application 121, as described in detail below.

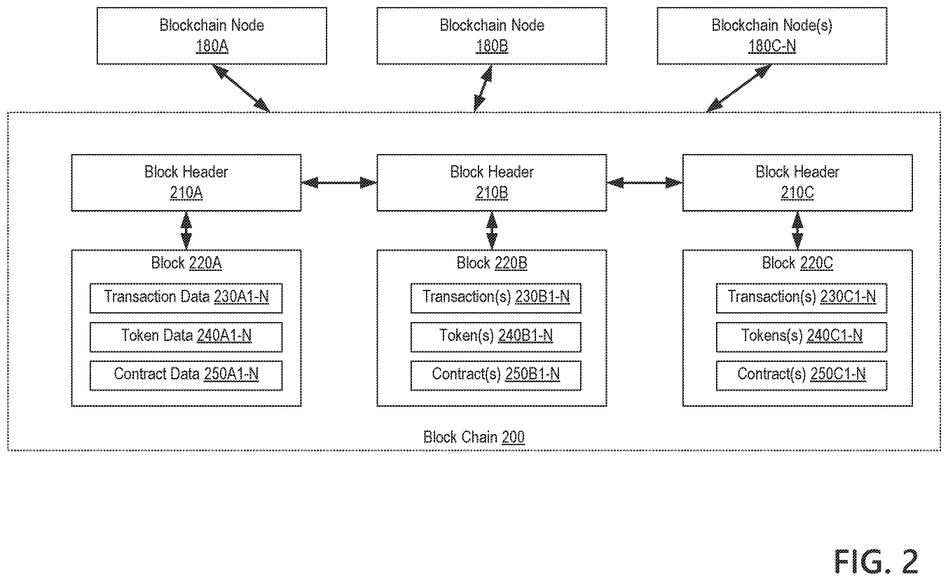

FIG. 2 illustrates an example blockchain 200, which may be maintained by the blockchain nodes 180. As described in more detail below, the blockchain 200 may store various data that may be used by the client application 121, including transaction data 230, token data 240, and contract data 250. The block chain 200 may include a number of blocks 220 associated with corresponding block headers 210, which may be linked to form a chain of blocks. Although the illustrated blockchain 200 only shows three example blocks in order to illustrate certain principles and functions, in practice many more blocks may be linked to form a much longer chain than illustrated. The blockchain nodes 180 may communicate with each other to generate new blocks, may use consensus algorithms to form a consensus that a particular new block should be considered the most recent block on the chain, and may perform other such functions for extending the block chain by generating new blocks. Each block 220 may include data about one or more transactions 230, tokens 240, and/or contracts 250.

In general, transaction data 230 may store data related to blockchain transactions, such as data indicating that blockchain tokens have been moved from one account to another, data indicating a contract that has been added to the chain, data indicating a user interaction with a contract, data indicating a proposal or query that has been added to the chain, data indicating a user interaction with a proposal or query, and other such data. Token data 240, in turn, may include data about a current owner of a particular token, additional data (e.g., unique identifiers in the case of non-fungible tokens) and any other data about tokens stored on the chain. In embodiments, token data 240 may also be stored as transaction data 230. Contract data 250 may include data about smart contracts that may be stored on the blockchain 200, that may provide various actions when users cause interactions with functions of the contracts. In embodiments, proposals and queries may be stored and submitted to a blockchain 200 using smart contract, and the proposals and/or queries may include various information (e.g., links to and/or hashes of off-chain data, textual information, etc.). For example, a proposal may include submitter data (e.g., a user name, textual information such as a title and description of the proposal, a hash/link to media content associated with the proposal, etc.), data for storing the proposal in one or more proposal-related smart contracts that provide proposal-related functions, and a bounty for incentivizing interaction with the proposal. This data may be stored as contract data 250, token data 240, and/or transaction data 230 as appropriate.

In embodiments, the blockchain 200 may be configured to support creative credits (e.g., tokens), which may be pre-mined for presale purchases and/or may be mined over time by blockchain nodes 180 that validate transactions on the blockchain 200. In embodiments, the blockchain 200 may have a delegated proof-of-stake consensus model, a proof of work consensus model, or any other consensus model. In embodiments, the mining inflation rate may be reduced over time (e.g., in order to work its way to 0%). Thus, credits (tokens) may be pre-mined and mined post-launch through operating validator nodes on an ongoing basis. In embodiments, mined credits may be sold on the client application 121 (e.g., at $1 per creative credit, based on market value plus a service charge, etc.). Thus, users may earn mined tokens by operating a validator node, purchasing mined credits through the client application 121, or using other methods described herein.

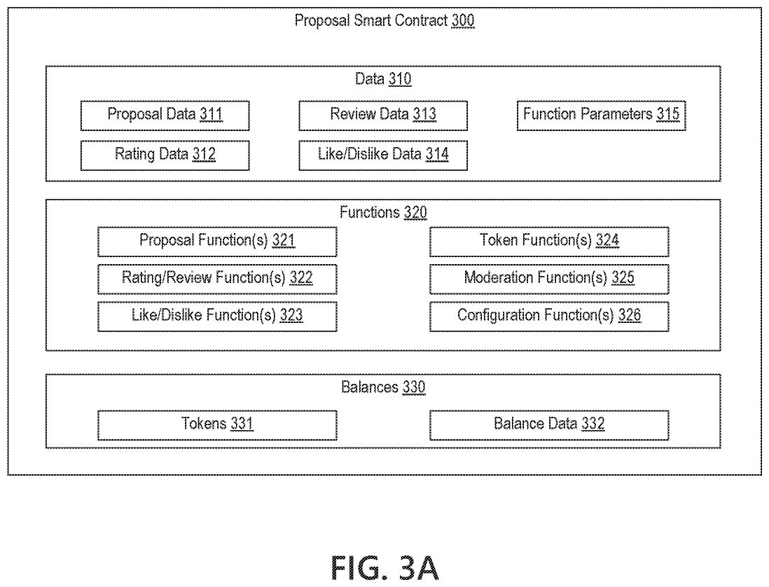

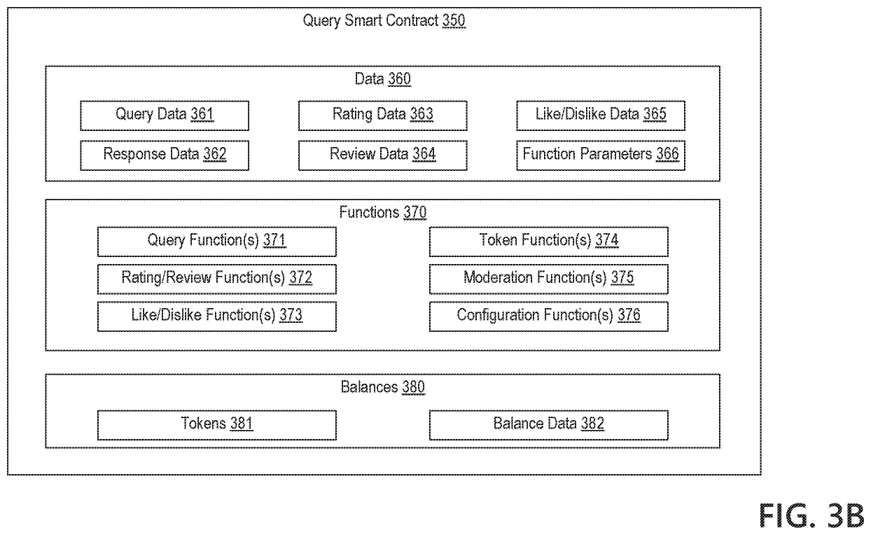

FIG. 3A illustrates an example of a proposal smart contract 300, which may be used to store data 310 including proposal data and data related to proposals, may contain one or more functions 320 for implementing on-chain features related to proposals (e.g., for storing and/or interacting with proposal data on a blockchain) as described herein, and may contain one or more balances 330 for storing tokens related to proposals. In some embodiments, although the proposal smart contract 300 is illustrated as a single exemplary smart contract, different smart contracts may be used for various features ascribed to the proposal smart contract 300. For example, a proposal storage smart contract may be used to store proposal data 310, a proposal controller smart contract may be used to provide one or more functions 320 related to stored proposal data 310, and a spendable smart contract may be used to store balances 330 related to proposal data 310. Accordingly, the proposal smart contract 300 should be understood as one implementation of the features described herein, with other implementations being possible.

In embodiments, the data 310 may include one or more data structures (e.g., tables) for storing the various data, such as a first data structure for storing the proposal data 311, a second data structure for storing the rating data 312, a third data structure for storing the review data 313, a fourth data structure for storing the like/dislike data 314, and/or a fifth data structure for storing the function parameters 315. Additionally or alternatively, some of the data structures may be combined, such that, for example, the rating data 312 and the review data 313 may be stored in a single data structure. In embodiments, the proposal data 311 may be stored in various data structures that may correspond to different submission periods, with, for example, a first data structure including the proposals submitted for a first submission period, a second data structure including the proposals submitted for a second submission period, and/or the like. In these embodiments, some or all of the other data (e.g., the rating data 312, review data 313, and/or like/dislike data 314) may or may not be similarly separated into data structures by submission period and/or some or other criteria.

In some embodiments, some or all of the data 310 may be immutable data that may not be modified once submitted. For example, one or more of the functions 320 described below may be configured to receive proposal data 311, rating data 312, review data 313, and/or like/dislike data 314 and create data structure values (e.g., table entries) corresponding to the received data, but may not be configured to edit or remove the received data once stored. Additionally or alternatively, some or all of the data 310 may be mutable data that may be edited after storage. For example, iterator data indicating, for example, a count of likes or dislikes related to a particular rating or review may be an example of a mutable attribute that may be edited (e.g., by increasing a like or dislike count as more likes or dislikes are received). As another example, each proposal, rating, review, like or dislike may be associated with a number of tokens, which may change over time as additional tokens are added to a bounty, staked to a review, rating, like or dislike, or distributed out to users from one or more balances 330 as described in more detail below.

In some embodiments, the data 310 may include hash values of data stored on-chain or off-chain in order to provide verification that some or all of the data 310 (e.g., the immutable data values) has not been modified after being received by the proposal smart contract 300. In these embodiments, the hash values may be calculated using a hash function that takes, as input, one or more data values of the received proposal data 311, rating data 312, review data 313, and/or like/dislike data 314. In embodiments, these hash values may be calculated and stored on-chain by a smart contract (e.g., the proposal smart contract 300) and/or may be calculated off-chain (e.g., by the server platform 110) and then stored on-chain.

The data 310 may include proposal data 311, which may comprise data for a plurality of proposals. In some embodiments, each proposal includes one or more data values, some or all of which may be stored on-chain, and some or all of which may be stored off-chain. Such data values may include a title data value, description data value, a data value indicating a submitter of the proposal (e.g., a name and/or blockchain account associated with the submitter), a number of tokens associated with the proposal (e.g., as a bounty), one or more unique identifiers for the proposal, hashes/links to one or more media assets associated with a proposal, an indicator of whether the proposal has not yet been moderated or has been approved or denied by a moderator, and/or hash values of any or all of the above data values. In some embodiments, each proposal may include a hash value and/or a link to off-chain data (e.g., an IPFS link). In these embodiments, the remaining data values may be stored off-chain in order to minimize on-chain transactions while still providing for data auditability.

The data 310 may further include rating data 312, which may comprise one or more ratings, where each rating is associated with a particular proposal. The rating data 312 may include one or more numerical scores, one or more hashes of the numerical scores, one or more data values indicating a submitter of the rating (e.g., a name and/or blockchain account), one or more data values indicating a number of tokens staked to the rating, and/or one or more hashes/links to rating data stored off-chain (e.g., IPFS links). In some embodiments, the rating data may include one or more sub-scores corresponding to different aspects of a proposal. For example, for a proposal related to a film project, a first sub-score may be a commercial viability sub-score, a second sub-score may be a plotline score, a third sub-score may be a characters score, etc. Additionally or alternatively, the rating data 312 may include an overall score, which may be an average (e.g., a weighted average) of the sub-score, or may be independent of the sub-scores. In embodiments, the rating data 312 may further include type data for a rating that specifies what each sub-score for a particular rating indicates. For example, a particular rating may be associated with a rating type indicator specifying that the rating is for a film proposal, and the rating data 312 may further store data indicating that, for film proposal ratings, a first sub-score is a commercial viability sub-score, etc. In these embodiments, the type indicator and/or a separate indicator may further specify which submission period a rating corresponds to (e.g., if different submission periods use different scores and/or sub-scores).

The data 310 may further include review data 313, which may comprise one or more reviews, where each review is associated with a particular proposal and/or a particular rating. The review data 313 may include one or more numerical scores and/or one or more other data values indicating, for example, text of a review, a hash/link to a video review, and/or other review content, one or more hashes of the data values, one or more data values indicating a submitter of the review (e.g., a name and/or blockchain account), one or more data values indicating a number of tokens staked to the review, and/or one or more hashes/links to other review data stored off-chain (e.g., IPFS links). In some embodiments, the review data may include any of the rating data 312 described above.

The data 310 may further include like/dislike data 314, which may comprise a plurality of like or dislike indications, with each like or dislike indication associated with a particular rating and/or review. In embodiments, the like/dislike data 314 may include, for each like/dislike, a data value indicating a like or a dislike, a data value indicating a submitter of the like or dislike (e.g., a name and/or blockchain account), a data value indicating a number of tokens staked to the like or dislike, and/or the like. Additionally or alternatively, the like/dislike data 314 may include a value (e.g., an iterator) indicating how many likes or dislikes a given rating or review has received. In some embodiments, like/dislike data may further include likes or dislikes for a proposal (e.g., likes or dislikes may be applied to ratings, reviews, and/or proposals separately).

In embodiments, although the reviews and ratings are described above in relation to proposals, the reviews and ratings may also be applied to other reviews or ratings, such that a user may review another user's review, rate another user's review, review another user's rating, and/or the like. In these embodiments, each review or rating may indicate the proposal, review, and/or rating to which it is responding. In some embodiments, the proposal smart contract 300 may enforce a limitation on the number of nested reviews or ratings (e.g., a user may review another review, but may not review a review of a review, or the like.).

In embodiments, the data 310 may further include function parameters 315, which may configure the operation of the various functions 320. Accordingly, the function parameters 315 are discussed in more detail below.

The functions 320 may include one or more smart contract functions configured to provide functionality for receiving data related to proposals, ratings, reviews, likes or dislikes, etc. and storing related data on-chain (e.g., as various data 310). For example, the functions may include proposal functions 321 for receiving proposals and storing the proposals as the proposal data 311, viewing the proposal data 311, and/or editing the proposal data 311, rating/review functions 322 for receiving ratings and/or reviews and storing the ratings and/or reviews as rating data 312 and/or review data 313, viewing the rating data 312 and/or review data 313, and/or editing the rating data 312 and/or review data 313, and like/dislike functions 323 for receiving likes and/or dislikes and storing the likes and/or dislikes as like/dislike data 314, viewing the like/dislike data 314, and/or editing the like/dislike data 314. Additionally or alternatively, the functions may include one or more token functions 324 for adding tokens to a bounty for a proposal, staking tokens to reviews, ratings, or likes and dislikes, and the like. Additionally or alternatively, the functions may include moderation functions 325 for finding and returning (e.g., to a moderator device) lists of unmoderated proposals, finding and returning lists of proposals that have been approved by a moderator, and/or finding and returning lists of proposal that have been denied by a moderator. Additionally or alternatively, the functions may include configuration functions 326 for modifying the operation of the other functions and/or data structures of the data 310. For example, an operator of the server platform 110 may use the configuration functions to create a new data table for storing proposals for an upcoming submissions period, may modify data indicating, for example, what the rating sub-scores represent for the upcoming submissions period, and may modify other data used to configure the various other functions.

In embodiments, the function restrictions 315 be used to configure the operation of one or more functions 320. The function parameters 315 may be used check and enforce certain limits on the data received by the functions 320. For example, the function parameters 315 may indicate that no more than a particular number of proposals may be submitted during a given proposal submission period, that ratings must fall within a certain range, that reviews may contain no more than a certain number of words, and other such restrictions. The function parameters 315 may further restrict access to the functions based on various criteria. For example, the function parameters may indicate that users may not use a moderation function 325 unless they are associated with a reputation score that is above a certain threshold. Additionally or alternatively, the function parameters may restrict access to the configuration functions 326 to certain account (e.g., an account associated with the operator of the server platform 110) and/or to accounts with certain cryptographic keys.

The balances 330 may include one or more tokens 331 that are associated with various proposals, ratings, reviews, and/or likes and dislikes. In embodiments, as described in more detail below, a proposal may be associated with a bounty balance, which may include a number of tokens 331 that may be used to reward users that interact with the proposal, such as by providing reviews, ratings, likes or dislikes, moderating the proposal, etc. In some embodiments, the bounty may receive contributions from the submitter of the proposal and/or from other users (e.g., as donations). Additionally or alternatively, the balances 330 may further include tokens 331 that are staked to particular reviews, ratings, likes or dislikes, and the like. In embodiments, the balances 330 may include a single pool of tokens 331 and balance data 332 indicating how many tokens are associated with each proposal, rating, review, like, dislike, etc. In these embodiments, the balance data 332 may be kept updated to indicate, for example, changes to the various balances as tokens are deposited or withdrawn (e.g., using token functions 324).

FIG. 3B illustrates an example of a query smart contract 350, which may be used to store data 360 including query and response data related to queries, may contain one or more functions 370 for implementing on-chain features related to queries (e.g., for storing and/or interacting with query data on a blockchain) as described herein, and may contain one or more balances 380 for storing tokens related to queries. In some embodiments, although the query smart contract 350 is illustrated as a single exemplary smart contract, different smart contracts may be used for various features ascribed to the query smart contract 350. For example, a query storage smart contract may be used to store query data 360, a query controller smart contract may be used to provide one or more functions 370 related to stored query data 360, and a spendable smart contract may be used to store balances 380 related to query data 360. Accordingly, the query smart contract 350 should be understood as one implementation of the features described herein, with other implementations being possible.

In embodiments, the data 360 may include one or more data structures (e.g., tables) for storing the various data, such as a first data structure for storing the query data 361, a second data structure for storing the response data 362, a third data structure for storing the rating data 363, a fourth data structure for storing the review data 364, a fifth data structure for storing the like/dislike data 365, and/or a sixth data structure for storing the function parameters 366. Additionally or alternatively, some of the data structures may be combined, such that, for example, the rating data 363 and the review data 364 may be stored in a single data structure.

In some embodiments, some or all of the data 360 may be immutable data that may not be modified once submitted. For example, one or more of the functions 370 described below may be configured to receive query data 361, response data 362, rating data 363, review data 364, and/or like/dislike data 365 and create data structure values (e.g., table entries) corresponding to the received data, but may not be configured to edit or remove the received data once stored. Additionally or alternatively, some or all of the data 360 may be mutable data that may be edited after storage. For example, iterator data indicating, for example, a count of likes or dislikes related to a particular rating or review may be an example of a mutable attribute that may be edited (e.g., by increasing a like or dislike count as more likes or dislikes are received). As another example, each query, response, rating, review, like or dislike may be associated with a number of tokens, which may change overtime as additional tokens are added to a query bounty, staked to a response, review, rating, like or dislike, or distributed out to users from one or more balances 380 as described in more detail below.

In some embodiments, the data 310 may include hash values of data stored on-chain or off-chain in order to provide verification that some or all of the data 360 (e.g., the immutable data values) has not been modified after being received by the proposal smart contract 300. In these embodiments, the hash values may be calculated using a hash function that takes, as input, one or more data values of the received query data 361, response data 362, rating data 363, review data 364, and/or like/dislike data 365. In embodiments, these hash values may be calculated and stored on-chain by a smart contract (e.g., the query smart contract 350) and/or may be calculated off-chain (e.g., by the server platform 110) and then stored on-chain.

The data 360 may include query data 361, which may comprise any or all of the data values discussed above for the proposal data 311. In embodiments, a query may differ from a proposal in that the query may receive responses in the form of response data 362, may be unassociated with any submission period, may be unassociated with a request to receive, and/or the like. Additionally or alternatively the query data 361 may have more of fewer data values than the proposal data 311.

The data 360 may further include response data 362, which may comprise one or more responses to the query, where each response is associated with a particular query. The response data 362 may include one or more data values indicating, for example, text of a response, hashes/links to one or more media assets, such as a video response or other response content, one or more hashes of the response data values, one or more data values indicating a submitter of the response (e.g., a name and/or blockchain account), one or more data values indicating a number of tokens staked to the response, and/or one or more hashes/links to other response data stored off-chain (e.g., IPFS links).

The data 360 may further include rating data 363, review data 364, like/dislike data 365, and function parameters 366. In embodiments, the rating data 363 may include the same types of data as the rating data 312, the review data 364 may include the same types of data as the review data 313, and/or the like/dislike data 365 may include the same types of data as the like/dislike data 314. Accordingly, any of the above disclosure referring to the rating data 312, review data 313, and/or like/dislike data 314 may apply equally to the rating data 363, review data 364, and/or like/dislike data 365. Additionally or alternatively, each of the rating data 363, review data 364, and/or like/dislike data 365 may have more or fewer data values than the rating data 312, review data 313, and/or like/dislike data 314. In embodiments, the ratings, reviews, likes, and dislikes indicated by the rating data 363, review data 364, and/or like/dislike data 365 may relate to a particular query stored as query data 361, a particular response stored as response data 362, or both.

Additionally, the function parameters 366 may configure the operation of the various functions 370, in a similar manner as described above for the function parameters 315. For example, the function parameters 315 may indicate that no more than a particular number of queries may be submitted within a particular time period, that no more than a particular number of responses may be submitted per query, and/or the like.

The functions 370 may include one or more smart contract functions configured to provide functionality for receiving data related to queries, responses, ratings, reviews, likes or dislikes, etc. and storing related data on-chain (e.g., as various data 360). For example, the functions may include query functions 371 for receiving queries and/or responses and storing the queries and/or responses as the query data 361 and/or response data 362, viewing the query data 361 and/or response data 362, and/or editing the query data 361 and/or response data 362. In embodiments, the rating/review functions 372, like/dislike functions 373, token functions 374, moderation functions 375, and/or configuration functions 376 may be configured to perform similar and/or the same operations as described above for the rating/review functions 322, like/dislike functions 323, token functions 324, moderation functions 325, and/or configuration functions 326.

The balances 380 may include one or more tokens 381 that are associated with various queries, response, ratings, reviews, and/or likes and dislikes. In embodiments, as described in more detail below, a query may be associated with a bounty balance, which may include a number of tokens 381 that may be used to reward users that interact with the query, such as by providing responses, reviews, ratings, likes or dislikes, moderating the query, etc. In some embodiments, the bounty may receive contributions from the submitter of the query and/or from other users (e.g., as donations). Additionally or alternatively, the balances 380 may further include tokens 381 that are staked to particular responses, reviews, ratings, likes or dislikes, and the like. In embodiments, the balances 380 may include a single pool of tokens 381 and balance data 382 indicating how many tokens are associated with each query, response, rating, review, like, dislike, etc. In these embodiments, the balance data 382 may be kept updated to indicate, for example, changes to the various balances as tokens are deposited or withdrawn (e.g., using token functions 384).

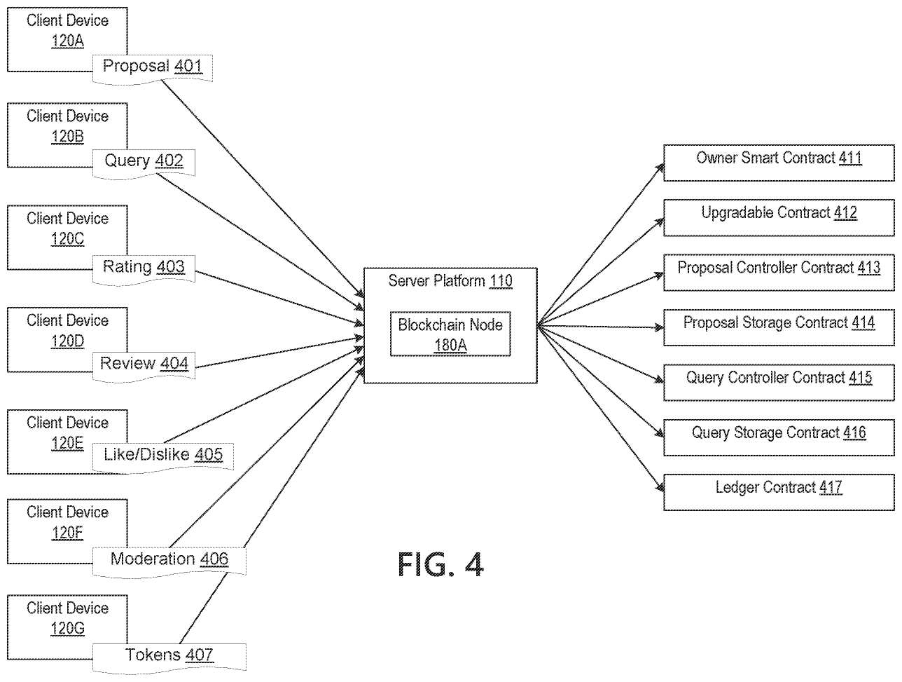

FIG. 4 illustrates an example data flow showing various types of data that may be received from client devices 120 and used to generate data for storage on a blockchain 200 (e.g., using various smart contracts). In the illustrated example, various client devices 120A-F transmit various types of data to a server platform 110 (which may include a blockchain node 180A), which in turn causes data to be written to one or more of a plurality of smart contracts 411-417. However, it should be understood that the illustrated number of client devices and smart contracts is merely exemplary. For example, a single client device (e.g., client device 120) may transmit one or more proposals 401, queries 402, ratings 403, reviews 404, likes or dislikes 405, moderations 406, and/or tokens 407 in the course of interacting with one or more communities as described herein. Moreover, although the illustrated data flow example shows the use of smart contracts 411-417, in embodiments more or fewer smart contracts may be used. Additionally, the use of a server platform 110 may not be required; for example, other blockchain nodes 180b-n may be usable to cause data to be stored and/or written onto a blockchain 200 without requiring the server platform 110.

Exemplary smart contracts may include an owner smart contract 411 configured to manage the other smart contracts (e.g., to replace another smart contract with an updated version of the smart contract, to call privileged functions of other smart contracts, etc.). Additionally or alternatively, an upgradable contract 412 may be configured to store updateable information for the current version of each contract (e.g., an address that may be updated by the owner smart contract 411) and/or route traffic between the owner smart contract and the current version of each contract. Additionally or alternatively, a proposal controller contract 413 may be configured to receive proposal information created by users, store the proposal information in the proposal storage contract 414, and/or otherwise provide functions for interacting with proposal data. Similarly, a query controller contract 415 may be configured to receive query information created by users, store the query information in the query storage contract 416, and/or otherwise provide functions for interacting with query data. Additionally or alternatively, a ledger smart contract 417 may store a ledger of internal transactions such as votes (e.g., upvotes or downvotes), likes or dislikes, transfers from one address to another, etc. The ledger smart contract 417 may use internal addresses and wallets assigned to various accounts in order to allow for internal transactions that avoid transactions on the blockchain 200 (e.g., in order to avoid gas fees for microtransactions such as voting, liking, etc.). The ledger contract 417 may thus record signed internal transactions in order to enable microtransactions while avoiding downsides associated with gas fees and other downsides or recording every transaction on the blockchain 200.

In embodiments, one or more client devices may submit a proposal 401 to a server platform 110. The proposal 401 may include various data, including textual data, audio/video/image data, hashes/links to data stored elsewhere (e.g., via IPFS), and/or the like, as described elsewhere herein. In embodiments, the server platform 110 (e.g., via blockchain node 180) may then update one or more of the blockchain smart contracts. For example, the server platform 110 may cause a transaction that updates information about the submitter of the proposal 401 in the owner smart contract 411, may call one or more smart contract functions of the proposal controller contract 413, and/or may cause storage of some or all of the proposal 401 data in the proposal storage contract 414. In embodiments, a submission of a proposal 401 may be accompanied by a submission of one or more tokens 407 (e.g., a proposal submission fee, a proposal bounty, etc.), which be associated with a cloud wallet, hardware wallet, or any other user wallet. In these embodiments, the server platform 110 may cause transfer of the tokens 407 to an account maintained by a ledger contract 417.

In embodiments, one or more client devices may submit a query 402 (e.g., and/or a query response) to a server platform 110. The query 402 may include various data, including textual data, audio/video/image data, hashes/links to data stored elsewhere (e.g., via IPFS), and/or the like, as described elsewhere herein. In embodiments, the server platform 110 (e.g., via blockchain node 180) may then update one or more of the blockchain smart contracts. For example, the server platform 110 may cause a transaction that updates information about the submitter of the query 402 in the owner smart contract 411, may call one or more smart contract functions of the query controller contract 415, and/or may cause storage of some or all of the query 402 data in the query storage contract 416. In embodiments, a submission of a query 402 may be accompanied by a submission of one or more tokens 407 (e.g., query submission fee, a query bounty, etc.), which be associated with a cloud wallet, hardware wallet, or any other user wallet. In these embodiments, the server platform 110 may cause transfer of the tokens 407 to an account maintained by a ledger contract 417.

In embodiments, a ledger contract 417 may be configured to manage the collection and payment of some or all fees paid using the client application 121 (e.g. submission fees, bounty fees, fees for token purchases, etc.). For example, submitters of proposals and/or queries may be required to pay fees as part of the submissions, which may be set based on, for example, a financing award pool associated with a particular proposal selection period. In these embodiments, the ledger contract 417 may be configured to collect payment (e.g., as tokens) for these fees.

In some embodiments, proposal and/or query submitters may also submit community awards with their submissions, such as tickets to a film, a line in the credits, extra role opportunities, merchandise, etc., that may be exchangeable upon specified conditions being met (e.g., another user adding to a submission bounty). In some embodiments, these awards may be associated with NFTs. In these embodiments, a ledger contract 417 or some other contract may be configured to receive tokens in order to meet the specified conditions for receiving the non-token items, and one or more smart contracts (e.g., a proposal controller contract 413 and/or proposal storage contract 414) may be configured to transfer the community awards (e.g., NFTs) to users who meet the specified conditions.

In embodiments, one or more client devices may submit a rating 403, review 404, and/or like/dislike 405 to a server platform 110. The rating 403, review 404, and/or like/dislike 405 may include various data, including textual data, audio/video/image data, hashes/links to data stored elsewhere (e.g., via IPFS), and/or the like, as described elsewhere herein. The rating 403, review 404, and/or like/dislike 405 may further be associated with a particular proposal 401, query 402, rating 403, and/or review 404 (e.g., the rating or review may be a rating or review of a proposal 401 or query 402, or may be a response to another rating or review; the like/dislike may be of a proposal 401, query 402, rating 403, or review 404, etc.); accordingly the rating 403, review 404, and/or like/dislike 405 may include an identifier of the particular proposal 401, query 402, rating 403, and/or review 404. In embodiments, the server platform 110 (e.g., via blockchain node 180) may then update one or more of the blockchain smart contracts. For example, the server platform 110 may cause a transaction that updates information about the submitter of the rating 403, review 404, and/or like/dislike 405 in the owner smart contract 411, may call one or more smart contract functions of the proposal controller contract 413 (e.g., if the rating 403, review 404, and/or like/dislike 405 is related to a proposal 401) or query controller contract 415 (e.g., if the rating 403, review 404, and/or like/dislike 405 is related to a query 402), and may cause storage of some or all of the rating 403, review 404, and/or like/dislike 405 data in the proposal storage contract 414 or query storage contract 416 (e.g., as appropriate). In embodiments, a submission of a rating 403, review 404, and/or like/dislike 405 may be accompanied by a submission of one or more tokens 407 (e.g., for staking to the corresponding rating 403, review 404, and/or like/dislike 405), which be associated with a cloud wallet, hardware wallet, or any other user wallet. In these embodiments, the server platform 110 may cause transfer of the tokens 407 to an account maintained by a ledger contract 417.

In embodiments, one or more client devices may submit a moderation 406 to a server platform 110. The moderation 406 may include various data, including an approval or denial decision, textual data indicating a reasons for the approval or denial, and the like. The moderation 406 may indicate a particular proposal 401 or query 402 that is being moderated; accordingly the moderation 406 may include an identifier of the particular proposal 401 or query 402. In embodiments, the server platform 110 (e.g., via blockchain node 180) may then update one or more of the blockchain smart contracts. For example, the server platform 110 may cause a transaction that updates information about the submitter of the moderation 406 in the owner smart contract 411, may call one or more smart contract functions of the proposal controller contract 413 (e.g., to set a moderation flag for a corresponding proposal 401) or query controller contract 415 (e.g., to set a moderation flag for a corresponding query 402), and may cause storage of the moderation 406 in the proposal storage contract 414 or query storage contract 416 (e.g., as appropriate). In embodiments, a submission of a moderation 406 may be accompanied by a submission of one or more tokens 407 (e.g., for staking to the moderation 406), which be associated with a cloud wallet, hardware wallet, or any other user wallet. In these embodiments, the server platform 110 may cause transfer of the tokens 407 to an account maintained by a ledger contract 417.

In embodiments, one or more client devices may submit one or more tokens 407 to a server platform 110. In these embodiments, the tokens 407 may be stored on a hardware wallet, in a cloud wallet, and/or in any other wallet. The tokens 407 may be submitted as part of a donation to a proposal 401 bounty or a query 402 bounty, may be staked to a particular rating 403, review 404, like/dislike 405, or moderation 406, or for any other purpose. In embodiments, the server platform 110 (e.g., via blockchain node 180) may then update one or more of the blockchain smart contracts. For example, the server platform 110 may cause a transaction that updates information about the submitter of the tokens 407 in the owner smart contract 411, may update data in a proposal storage contract 414 or query storage contract 416 when the tokens 407 relate to a proposal 401 or query 402, and may cause transfer of the tokens 407 to an account maintained by a ledger contract 417.

Either prior to or after the proposal 401, query 402, rating 403, review 404, like/dislike 405, moderation 406, and/or tokens 407 data is added to the blockchain 200, the server platform 110 may store some or all of the data in an off-chain database (e.g., using a database server cluster 150), as well as generate hash(es) for the proposal 401, query 402, rating 403, review 404, like/dislike 405, moderation 406, tokens 407, and/or content associated with any of the foregoing (e.g., hashes of content stored off-chain). The hash(es) may be added to the blockchain 200 (e.g., in the proposal smart contract 414 or query storage contract 416, as appropriate). In some embodiments, the data stored on-chain (e.g., in the proposal storage contract 414 or query storage contract 416) may include the hash information, one or more identifiers of the proposal 401, query 402, rating 403, review 404, like/dislike 405, moderation 406, and/or tokens 407, one or more hashes of and/or links to audio/video/image data, and other such data that may be efficient to store on-chain, whereas other data (e.g., audio/video/image data, large amounts of textual data, etc.) may be stored off-chain. Alternatively, all of the content associated with a proposal 401, query 402, rating 403, review 404, like/dislike 405, moderation 406, and/or tokens 407 may be stored on the blockchain 200.

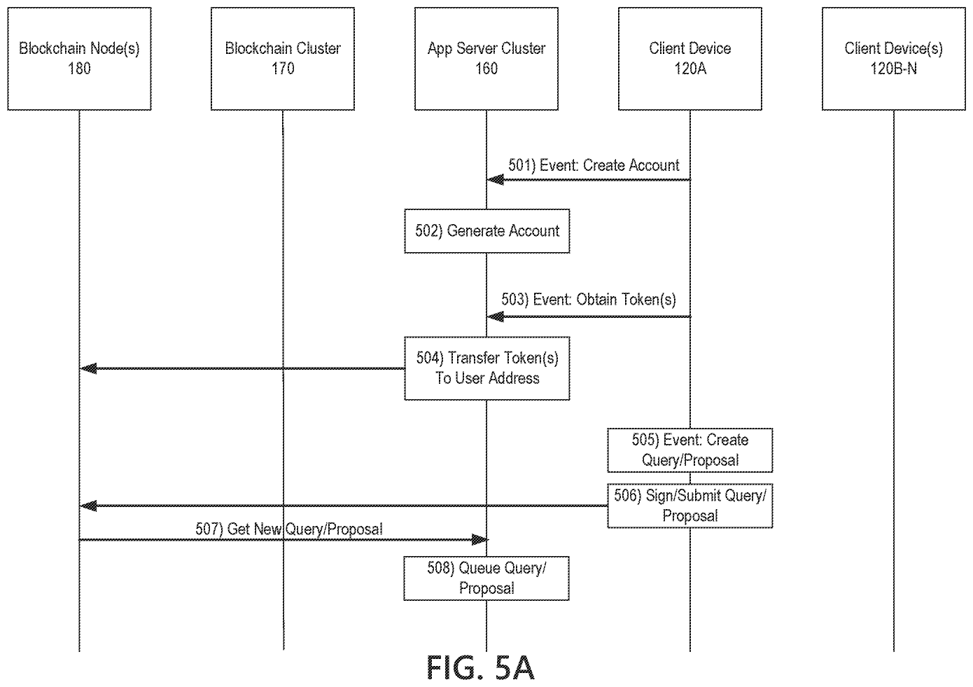

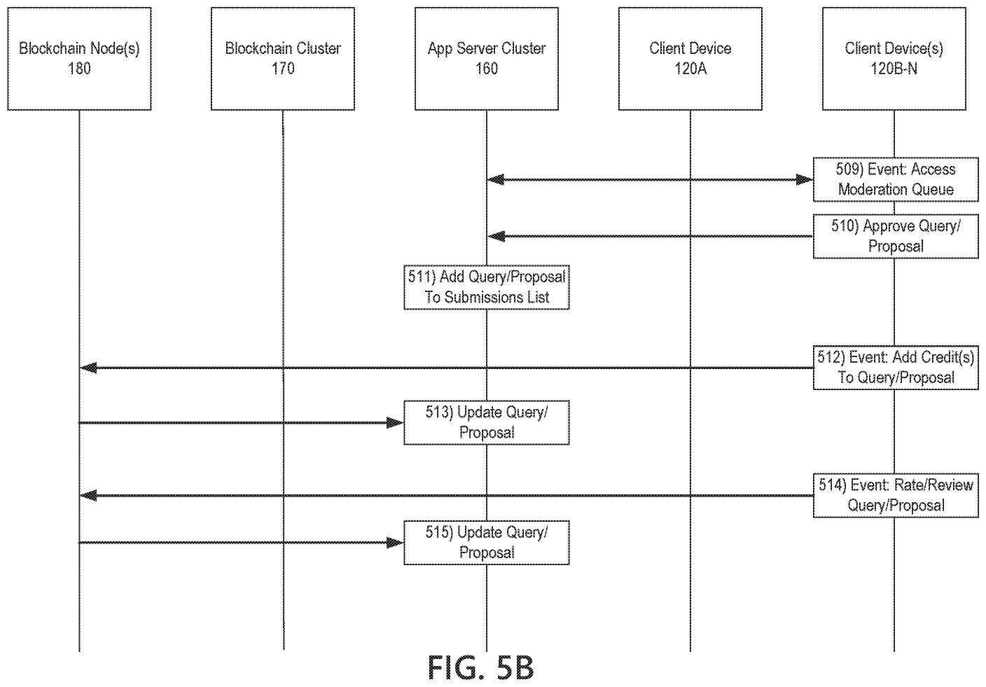

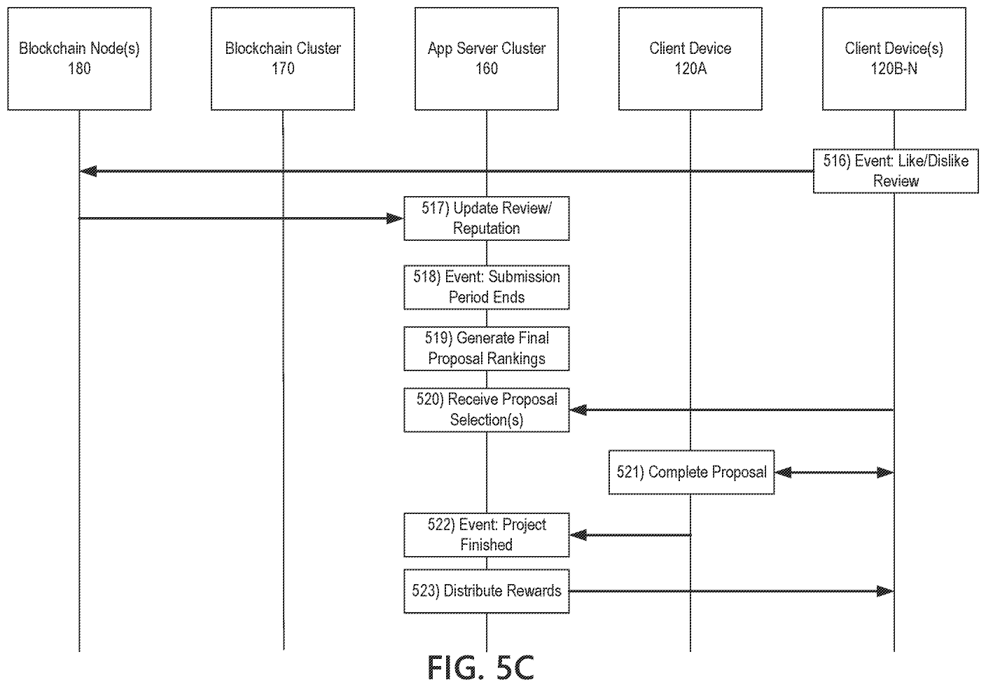

FIGS. 5A-5C illustrate an example flow for a user-generated proposal or query that may be submitted via the client application 121 in order to illustrate several functionalities of the client application 121, server platform 110, and/or various smart contracts as described herein. The example flow is an illustrative description of one particular flow of interactions involving various devices described herein, but the possibility of other similar and modified interactions will also be apparent. For purposes of illustration, the example flow describes the submission of a proposal or query pertaining to a film or movie (i.e., a video), community interactions with the proposal or query (e.g., user ratings and reviews of a script and/or synopsis for a proposed movie), and ranking of the proposal or query, which may (in the case of a proposal) ultimately lead to receiving funding for the proposal. However, it should be understood that a similar process could be used to submit a proposal or query pertaining to any type of content. For example, a user might submit a proposal for a new startup company (e.g., to be reviewed and/or funded by potential customers, investors, etc.), a music album (e.g., to receive studio time, reviews, and/or funding from customers, music studios, etc.), and the like. Additionally, proposals could be submitted by a user associated with a large entity. As another example, an employee of a corporation could submit several proposals for a new product feature in order to solicit community engagement (e.g., from customers, partners, suppliers, members of the corporation, etc.). Similarly, a user could submit a query (e.g., a creative query) about any type of content, such as a request for community responses to a query about the movie industry, a request for community responses related to potential market demand for a new business, and/or the like. In the example of queries, some features of the flow described below may be omitted (e.g., a query may not be associated with a submission period, may not lead to a potential funding round, etc.). Accordingly, although the example below describes a certain order of steps, it should be understood that not all of the steps are required, and/or the steps may be performed in different orders.

In illustrative step 501, a user of the client device 120A may wish to sign up for a new account in order to join a community. A user may select a function to create an account via the client application 121, which generates an event that causes steps 501-502. The user may submit information (e.g., a user account name and password information) to the app server cluster 160 of the server platform 110. In addition, although not shown in FIG. 5A, the user may submit identity verification information (e.g., a user's legal name, date of birth, etc.) to the client application 121, which may send the information (e.g., via the KYC service 124) to a KYC service provider 130A. By using the KYC service provider 130A, the app server cluster 160 may be able to ensure the user's identity is verified without having to receive private information from the user. Additionally or alternatively, the KYC service provider 130 may allow for the determination of demographic information, which may (e.g., with a user's consent) be used for various analytic purposes as described in more detail below.

At step 502, the server platform 110 (e.g., via app server cluster 160) may generate an account for the user. In embodiments, generating an account may include generating one or more blockchain addresses for a user wallet (e.g. a cloud wallet), generating one or more secret keys for the user, and generating other such information for enabling the user to perform transactions with and/or otherwise interact with the blockchain 200. Although not shown in FIG. 5A, the app server cluster 160 may cause the database cluster 150 to store the user's account information in a database maintained by the database cluster 150. In embodiments, upon creation of an account, a default reputation score may be assigned to the new user. As described in more detail below, the reputation score may be updated over time based on various factors, including the user's submissions and associated ratings, the user's reviews/ratings compared to community reviews and/or ratings, how early the user submitted a review or rating, how many tokens were added to a bounty, numbers of staked tokens, and/or other factors as discussed in more detail below.

In embodiments, a user may need blockchain tokens 407 to perform several functions as described herein, such as to to submit a proposal 401 or query 402. A proposal 401 or query 402 may be submitted along with a bounty, which may be used to incentivize community engagement with the proposal 401 or query 402 Accordingly, in illustrative step 503, a user may initially obtain one or more token(s) prior to a proposal or query submission.

The user may obtain tokens 407 in several ways. For example, the user may obtain tokens by purchasing the tokens. A user may purchase tokens by submitting payment information via the client application 121 (e.g., via the payment service 125). The client application 121 may cause the client device 120 to send the payment information to a payment service provider 130B. If the payment is successful, the server platform 110 may be notified. Then, at step 504, the purchased tokens may be transferred to the user (e.g., to an address associated with a user wallet). The token transfer may take place off chain (e.g., it may not involve a blockchain transfer) or may take place on chain (e.g., the transfer may be recorded on the blockchain 200). If the transfer is recorded on the blockchain 200, the app server cluster 160 may cause a transaction of tokens to an address associated with the user. For example, the app server cluster 160 may command the blockchain cluster 170 to generate the transaction data, and blockchain cluster 170, in turn, may cause a blockchain node 180A to write the transaction to the blockchain 200.

As an alternative to purchasing tokens, users might earn tokens by performing other actions involving community engagement. For example, the server platform 110 may provide quizzes and other competitions, where users may compete to achieve a high score (e.g., by answering the most questions correctly). Users may be awarded with tokens for participating in the competition and/or based on their score. Again, the transfer of tokens to the user may take place either off chain or on chain, and thus may require blockchain transactions in some instances.

As another alternative, a user may earn tokens by engaging with other proposals stored on the blockchain, such as by moderating proposals, submitting reviews of proposals, and performing other such actions. In some cases, these actions may involve interaction with smart contracts. Examples of how a user may earn tokens for performing such actions are described in more detail below.

Additionally or alternatively, a user may earn tokens by setting up a blockchain node 180 and configuring it to mine tokens. In embodiments, users may be required to complete an educational tutorial that includes instructions on how to establish and operate a blockchain node (e.g., validator node) before operating one. Other organizations (e.g., besides users) may also operate validator nodes for the blockchain 200 and/or and earn tokens that may be sold and distributed.

At step 505, a user of the client device 120A may decide to submit a proposal or query. The user may therefore begin a proposal or query submission process via the client application 121, which causes steps 505-508 to occur. To submit a proposal or query, the client application 121 may require the user to submit several pieces of information, which may vary according to context. A user may access the client application 121 via the client device 120A to review the submission requirements. In the film submission context, the client application 121 may list a submission period (e.g., a ninety day period with a start date and end date during which submissions may be accepted, reviewed, ranked, etc.), a type of submission (e.g., the submission period may be for documentary films with a certain theme), one or more content items required for the submission (e.g., a title, a description, a file including a script or synopsis, etc.), one or more optional content items (e.g., a trailer video), and the like. The user may enter, upload, and/or provide links to the various required and/or optional content items via the client application 121.

In addition, the user may be required to submit a bounty as part of the proposal or query submission process. The required bounty may include a minimum number of blockchain tokens (e.g., which may have been obtained as described above for steps 503-504), which may be used to incentivize community members to participate in moderating, reviewing, rating, developing, and otherwise assisting or providing feedback on the proposal. The user may provide more than a required minimum number of tokens for the bounty in order to incentivize additional reviews and other interactions. In addition to or as an alternative to the blockchain tokens, the bounty may include one or more non-fungible tokens and/or other tokens that community users may obtain based on their interactions with the proposal. In some embodiments, the proposal or query may be associated with a smart contract that may be configured to provide various tokens including as part of the bounty to community users in response to various conditions being met. For example, a submitting user may specify that a particular community user may receive a non-fungible token if the community user donates a certain number of a fungible tokens to a bounty associated with the submitting user's proposal or query. Later (e.g., when the proposal or query is submitted as described below), one or more smart contracts may be configured to provide the non-fungible tokens to any community user that meets the user-specified criteria.

At step 506, when the proposal or query is ready, the user may select a function (e.g., via the client application 121) to submit the proposal or query. The client application 121 may then sign (e.g., using a private key associate with the user account) the proposal or query and cause the proposal or query to be stored on the blockchain 200. To cause storage of the proposal on the blockchain 200, the client application 121 may cause the client device 120 to send a transmission to the blockchain node 180 to generate a new block 220 containing data for the new proposal.

The new proposal 401 or query 402 data stored on blockchain 200 may, as discussed above, include submitter data (e.g., data about the user who submitted the proposal), one or more tokens for a bounty, audio/video/image/data, and any other data that may be associated with a proposal or query. The data may be submitted to a corresponding proposal smart contract 300 (e.g., a proposal controller contract 413 and/or proposal storage contract 414) or query smart contract 350 (e.g., a query controller contract 415 and/or query storage contract 416), as appropriate. In embodiments, the contracts may be configured to receive the proposal or query data (e.g., using one or more smart contract functions), and store the received data and/or other data in one or more data structures associated with the smart contracts. Additionally or alternatively, the configured smart contracts may be configured to receive information from other users about the submitted proposal or query. For example, functions of the configured smart contracts may allow another community user to submit a rating and/or review of the proposal and to receive a portion of the bounty after the rating/review is submitted. As another example, configured smart contract functions may allow another user to contribute additional tokens to the proposal or query, which may be stored as part of the bounty, and thus may be used to incentivize additional community interactions with the proposal. In general, the smart contracts storing the proposal or query data may be configured to receive additional community interaction data, moderation data, and/or tokens, to generate ranking data for the proposal or query, to distribute bounty tokens to the community based on the community interacts, and the like.

At step 507, the blockchain cluster 170, which may be monitoring/listening for events on the blockchain 200 (e.g., via the blockchain node 180), may detect the new proposal 401 or query 402 added to the blockchain 200, and may obtain data about the corresponding proposal 401 or query 402. Upon obtaining the data, the server platform 110 may cause the data to be stored in an off-chain database (e.g., via the app server cluster 160 and/or the database server cluster 150) for easy access by a community of users that use the client application 121.

At step 508, the app server cluster 160 may add the submitted proposal to a moderation queue until it is approved by a moderator. A moderator may be required to approve the proposal before it can be accessed by the community. In embodiments, the moderator may use a set of standards for the approval process in order to screen out proposals or queries that include offensive, illegal, and/or harmful material. For example, moderators may filter out queries and/or proposals that contain spam, hate speech, racist comments, profanity, and/or other offensive material prior to making the proposal or query available via the client application 121. Although not shown in FIG. 5A, the moderation queue may be configured to allow for a second level review of moderation decisions if a proposal is denied.

In embodiments, the server platform 110 may perform one or more pre-moderation techniques to aid in moderation when the proposal or query is added to the moderation queue. For example, the server platform 110 may use machine learning techniques, sentiment analysis techniques, keyword lists (e.g., lists of profanity or offensive words), and other such techniques to flag one or more submissions as potentially abusive or otherwise including offensive content. In embodiments, a moderator may later review the outputs of the pre-moderation techniques as part of the moderation process.

Turning to FIG. 5B, at step 509, a moderator using another client device (e.g., a client device 120B, or any other of client devices 120A-N) may access the moderation queue to review the submitted proposal or query. The moderator may access, for example, a graphical user interface generated by the server platform 110 and/or client application 121 for viewing a moderation queue. The graphical user interface may display the proposals and/or queries that are awaiting moderation in the moderation queue. The moderator may then, using the client device 120, review the proposal or query, review one or more of the pre-moderation indications generated by the server platform 110, review any moderation instructions (e.g., defining moderation criteria), and decide to either approve or deny the submitted proposal or query.

In embodiments, community users may only access a moderation queue if they have a reputation score that is above a particular reputation score threshold and/or if their reputation score is above a certain percentile compared to the reputation scores of all users. Additionally or alternatively, moderators may be required to stake a number of tokens in order to be allowed to act as a moderator. In embodiments, moderators may be incentivized to moderate proposals or queries fairly and honestly because unfair moderation practices may cause the moderator to lose credit tokens and/or lose the ability to cam credit tokens, risk losing moderation stakes and/or status, and/or have their reputation scores reduced.

In embodiments, if a proposal or query is denied by a moderator, the submitter of the proposal or query may be allowed to appeal the denial decision to a second-level moderator of the proposal or query, who may affirm or reverse the denial. In some embodiments, appealing a moderation decision may require the staking of a certain number of tokens, which may or may not be lost if a second-level moderator decides that the proposal or query is clearly offensive. In embodiments, a second-level moderator may be a moderator that has a higher reputation score (e.g., above a higher absolute or percentile threshold) than a first-level moderator. Additionally or alternatively, a second-level moderator may be required to stake an additional number of tokens (e.g., as compared to a first-level moderator) to act as second-level moderator.

When a second-level moderator overrules a first-level moderator, in some embodiments, the overruled first-level moderator may lose one or more of a moderation status, an amount of staked tokens, and/or may have a reputation score reduced. In some embodiments, one or more of these enforcement actions may take place automatically when a first-level moderator is overruled (e.g., the server platform 110 may, upon receiving an indication that a moderation decision is overruled, automatically take the one or more enforcement actions). Additionally or alternatively, the second-level moderator may have the ability to indicate whether the first-level moderator was overruled because of abusive or bad faith moderation practices, or conversely due to a subjective disagreement, which may affect whether any enforcement actions are taken, the severity of the enforcement actions, etc.

At step 510, the moderator may (in this example flow) decide to approve the proposal or query by submitting an indication to the client application 121, which may, in turn, cause the client device 120B used by the moderator to send an approval to the app server cluster 160. Then, at step 511, the approved proposal or query may be added to a data structure (which may be stored on-chain and/or off-chain) of the submitted and approved proposals or queries. In embodiments, approved proposals may be added to a data structure for a current submission period, such that each submission period may use a different data structure. The contents of the data structure may be accessed via a page of the client application 121 so that various community members (e.g., using client devices 120B-N) can view, rate, review, develop, and otherwise interact with the different proposals or queries submitted by various users. Accordingly, in embodiments, the proposal or query data may be stored off-chain (e.g., in addition to storing some or all of the data on-chain) so that it may be available for quick retrieval and display by the client application 121.

The client application 121 may provide various views for interacting with the list of submitted and approved proposals and/or queries. For example, a user accessing the client application 121 may be able to view all submitted proposals ranked in order of newness, in order of score, in order of rating, and/or the like. Accordingly, in embodiments, the server platform 110 may, upon submission of the proposal and/or query, store data that may be used to rank, or otherwise order the proposals or queries. Again, such data may be stored on-chain (e.g., in a proposal storage contract 414 or query storage contract 416 as appropriate) and/or off-chain. For example, each proposal or query may be associated with a stored submission timestamp for ordering the proposals or queries by newness, a default score attribute (which may be updated over time based on various scoring criteria) for ordering the proposal or queries by score, and/or a default ranking attribute (which may be updated over time based on various ranking criteria) for ranking the proposal or queries. Accordingly, after a proposal or query has been approved by a moderator, it may be viewable via various user interface pages provided by the client application 121.

At step 512, another user (e.g., a user of a client device 120C, or any other of client devices 120A-N) may decide to add tokens to the submitted proposal or query (e.g., to increase the bounty associated with the proposal or query). In embodiments, adding tokens to a bounty may incentivize community participation. Thus, community users may add tokens when they wish to promote or support a particular proposal or query. In embodiments, to add tokens to a proposal or query, a user may select a function for adding a specified number of tokens to a proposal or query via the client application 121 (which may be connected to a user's wallet) and/or may view a blockchain address associated with a proposal or query via the client application 121, which the user may use to cause a transaction of a specified number of tokens to the proposal or query. In either case, the user's selections may cause the transmission of instructions to a blockchain node 180, which may in turn cause one or more blockchain transactions for transferring the tokens into the bounty associated with the proposal or query. In embodiments, such transactions may involve smart contract functions, such as one or more token functions 324 or token functions 374, and/or smart contract data updates, such as storage of tokens in balances 330 or 380 and/or in a ledger contract 417, updates to data stored in a proposal storage contract 414 and/or query storage contract 416, and/or the like.

Then, at step 513, the blockchain cluster 170 may detect that the additional tokens have been added to the proposal 401 or query 402 on the blockchain 200. Upon obtaining the updated data about the proposal or query, the server platform 110 may cause the updated proposal data to be stored off-chain (e.g., via the app server cluster 160 and/or the database server cluster 150) and/or made available for viewing by other users via the client application 121. Thus, when users access information about the proposal 401 or query 402 via the client application 121, they may be able to see that additional tokens have been added to a proposal, and therefore may be incentivized to engage with the proposal or query (e.g., by ranking or reviewing the proposal or query, providing a response to a query, etc.). Additionally or alternatively, the server platform 110 may update a score or ranking associated with the proposal or query based on the addition of tokens to the bounty associated with the proposal or query. For example, adding tokens may increase the score and/or ranking of the proposal or query.

At illustrative step 514, another user (e.g., a user of a client device 120D, or any other of client devices 120A-N) may decide to interact with the proposal 401 or query 402 by rating and/or reviewing the proposal or query. In embodiments, the community user may submit a rating. The rating may include one or more numerical scores, which may include an overall score and/or one or more sub-scores. In embodiments, the client application 121 may provide a graphical user interface screen for entering the various scores, and may provide information about the different scores based on the proposal or query being rated (e.g., for a film proposal, the sub-scores may be for characters, plot, commercial viability, etc., whereas different sub-scores may be used for other types of proposals or queries). Additionally or alternatively, the client application 121 may display sub-score information based on a current submission period for proposals, such that, for example, during a first submission period, a first set of sub-scores may be submitted, whereas for a second submission period, a second set of sub-scores may be submitted. In embodiments, the community user may submit a review (e.g., a textual review) in addition to, or as an alternative to, the rating. The review may comprise free-form content, such as text content, links to audio/video/image content, and/or the like.

Upon submission of the rating and/or review via the client application 121, the client device 120 may cause transmission of the rating/review data to the blockchain node 180, which may cause one or more blockchain transactions for writing some or all of the rating/review data to the blockchain 200. In embodiments, the ratings or reviews may be stored along with the corresponding proposal or query to which they pertain (e.g., in a proposal smart contract 300, query smart contract 350, proposal storage contract 414, and/or query storage contract 416).

Then, at step 515, the blockchain cluster 170 may detect that the rating and/or review has been added to the proposal 401 or query 402 on the blockchain 200 and update the corresponding proposal or query data. Upon obtaining the rating and/or review data, the server platform 110 may cause the rating and/or review to be stored off-chain (e.g., via the app server cluster 160 and/or the database server cluster 150) and/or made available for viewing by other users via the client application 121. Thus, when users access information about the proposal 401 or query 402 via the client application 121, they may be able to see the ratings and/or review of other users, may be able to interact with the ratings or review of other users (e.g., liking or disliking a review, responding to a review with another review, etc.), and the like.

In embodiments, a score and/or ranking of a query and/or proposal may be adjusted (e.g., by the server platform 110 and/or one or more smart contracts) based on the received rating and/or review. For example, a score and/or ranking may be adjusted upwards when a high rating is received, and adjusted downwards when a low rating is received. In embodiments, the server platform 110 and/or smart contracts may determine the score associated with a proposal or query based on a weighted average of all ratings associated with a query or proposal. The weight given to any particular rating may be based on several factors, including a reputation of the rater or reviewer (e.g., with ratings/reviews from higher reputation users being weighted more highly), a number of tokens staked to a reputation or review (e.g., with more staked tokens causing a greater weight), a number of likes or dislikes associated with a review or rating (e.g., with a high number of likes, low number of dislikes, and/or high ratio of likes to dislikes increasing the weight of a rating or review, and vice versa).

In some embodiments, ratings may be on a 1-10 scale. In some embodiments, they may be weighted according to a multi-factor formula. For example, a rater's reputation score may be most important in this formula. The client application 121 may further allow raters to lock/stake some or all of their creative credits (tokens) to an evaluation to increase its weight incrementally. In one example, the factors and their respective weights in the multi-factor formula may be as follows: reputation score (50% weight); number of creative credits locked on vote (20% weight); total creative credit holdings (5% weight); percentage of user's total creative credit holdings locked on vote (15% weight); and timing, whereby earlier votes may be weighted more heavily for setting the trends (10% weight). In this example, the composition of factors in the multi-factor formula may be designed to ensure that a user may not be able to unduly influence any poll, such as a poll regarding film fund financing, based solely on creative credit holdings.

Turning to FIG. 5C, at step 516, another user (e.g., a user of a client device 120E, or any other of client devices 120A-N) may interact with a rating/review associated with the proposal 401 or query 402 (e.g., a review submitted at step 514) by liking or disliking the rating/review, or otherwise providing feedback on the rating/review. In embodiments, the client application 121 may provide a graphical user interface screen for indicating that a user likes or dislikes ratings/reviews/etc. Upon submission of the like or dislike via the client application 121, the client device 120 may cause transmission of the like/dislike data to the blockchain node 180, which may cause one or more blockchain transactions for writing some or all of the like/dislike data to the blockchain 200. In embodiments, the like and dislikes may be stored along with the corresponding rating/review and/or proposal or query to which they pertain (e.g., in a proposal smart contract 300, query smart contract 350, proposal storage contract 414, and/or query storage contract 416).

Then, at step 517, the blockchain cluster 170 may detect that the like or dislike has been added to the rating/review on the blockchain 200 and update the corresponding rating/review and proposal or query data. Upon obtaining the like or dislike data, the server platform 110 may cause the like or dislike to be stored off-chain (e.g., via the app server cluster 160 and/or the database server cluster 150) and/or made available for viewing by other users via the client application 121. Thus, when users access information about ratings or reviews via the client application 121, they may be able to see how many other users like or disliked the ratings or reviews and the like.

In embodiments, a user's reputation score may be adjusted based on like or dislike data associated with that user's ratings or reviews. For example, if a user's reviews receive a large number of likes, a small number of dislikes, a high ratio of likes to dislike, and/or the like, the user's reputation score may be increased. Similarly, if a user's reviews receive more dislikes, the user's reputation score may be decreased. In embodiments, the server platform 110 may calculate a user's reputation score on a regular basis in order to keep the reputation scores updated. In these embodiments, the user's reputation scores may be updated by storing the reputation scores on the blockchain 200 (e.g., using a smart contract). Additionally or alternatively, a user's reputation score may be adjusted based on other factors (e.g., participating in daily quizzes, submitting or curating proposals and queries, highly rating proposals that ultimately win financing, and moderating proposals and queries without getting appealed.

At step 518, the app server cluster 160 may determine that a submission period has ended. As a result, the app server cluster 160 may stop providing (e.g., to the client application 121 running on the client devices 120A-N) information that allows further user interaction with submitted proposals. For example, the app server cluster 160 may cause the client application 121 to disable its functionality for submitting new content proposals for the submission period that has ended, disable functions for rating and/or reviewing proposals, disable functions for adding to a proposal bounty, disable functions for liking/disliking reviews, and the like.

In embodiments, at step 518, any tokens staked to ratings/reviews, likes and/or dislikes may be returned to the user who staked the tokens. In embodiments, data indicating how many tokens were staked may remain stored on the blockchain 200, for example for use in a final calculation of rankings (e.g., at step 519), for use in distributing rewards to users who engaged with the proposal or query (e.g., at step 523), and/or the like.

At step 519, the server platform 110 (e.g., via the app server cluster 160) may provide a final ranking of the submitted proposals. The server platform 110 may generate a final ranking based on one or more scores associated with each proposal submitted during a submission period. For example, the server platform 110 may generate, for each proposal, an overall score based on the various ratings, reviews, likes and/or dislikes associated with each proposal. As discussed above, the overall score may be generate using a weighted average of rating/review scores, where the individual rating/review scores are weighted more or less heavily based on the reputation score of the user who provided the rating/review, the time at which the rating/review was submitted (e.g., such that earlier ratings/reviews may be weighted more heavily), the number of likes and/or dislikes associated with the rating/review, the number of tokens staked to the rating/review, and/or the like. In embodiments, the server platform 110 may generate a final ranking that may narrow down submissions to three to five finalists through the review and rating process.

At step 520, various users (e.g., using one or more of client devices 120B-N) may view and select one or more of the ranked content proposals, and select one or more of the proposals for various actions. For example, one user may view the rankings of the submitted proposals, select a particular proposal 401 from the rankings, and elect to provide funding to the proposal 401. Another user may select a proposal 401 from the rankings and indicate that they are willing to provide mentorship to the submitter of the proposal. Another user may select a proposal 401 and decide to offer a loan to the submitter of the proposal. Thus, various users may decide to provide various forms of assistance to the proposal submitter to enable completion of the proposal.

In embodiments, a controlling organization and/or the users of the client application 121 may collectively select which the proposal(s) are most deserving of a financing award and/or other assistance (e.g., studio time, mentorship, etc.). In embodiments, a community-generated metric for selecting a proposal may involve any or all of the following metrics: the ratings submitted by users; the reputation scores of the users who rated a submission/proposal; the diversity of the users who rated the submission/proposal; the potential social impact of the submission/proposal; the artistic merit of the submission/proposal; and/or the commercial viability of the submission/proposal. In embodiments, various users may review the community-generated metrics and submit votes, and the server platform 110 may tally the votes to select one or more winners for receiving various types of assistance.

In embodiments, user votes may be weighted based on various criteria. For example, users may stake tokens to their votes in order to increase a weight associated with the user's vote. Additionally or alternatively, users' votes may be weighted based on one or more of reputation score, number of creative credits locked on vote, total creative credit holdings, and timing. In embodiments, each factors may be associated with individual weights as follows: reputation score (50% weight); number of credits locked on vote (20% weight); total credit holdings (5% weight); percentage of user's total credit holdings locked on vote (15% weight); and timing, whereby earlier votes may be weighted more heavily for setting the trends (10% weight).

At step 521, the user who submitted the proposal 401 may complete the proposal (e.g., may create the film described in the proposal) in cooperation and/or coordination with the users who elected to fund or otherwise assist with the project. As mentioned above, users may provide any form of assistance, and thus may cooperate in a myriad of ways, many of which are not shown or illustrated in the flow diagram. For example, various financing, revenue-sharing, and/or other arrangements may be made.

At step 522, after the user finishes the project, the user may indicate (e.g., via the client application 121) that the proposal is complete, and the indication may be received by the server platform 110 (e.g., the app server cluster 160). In embodiments, the app server cluster 160 may then notify other user devices (e.g., devices associated with collaborators) that the proposal is complete. In embodiments, the submitter of the proposal may upload (e.g., via the client application 121) one or more links to content associated with the proposal, and the server platform 110 in turn may make such content available to the other user devices.

At step 523, the app server cluster 160 may distribute rewards to community members for engaging with or contributing to the proposal 401 or query 402. For example, the bounty associated with a proposal may be distributed to the various users that provided ratings/reviews, likes or dislikes, moderation, or otherwise engaged with a particular query or proposal. In embodiments, the server platform 110 may determine a distribution of the bounty based on data stored on-chain (e.g., in a proposal smart contract 300, query smart contract 350, proposal storage contract 414, and/or query storage contract 416). For example, the bounty may be distributed to raters and/or reviewers based on how highly they rated or reviewed the proposal or query, how many likes or dislikes were associated with their ratings or reviews, and/or the like.

In embodiments, rewards may also be distributed from a rewards pool maintained by an operator of the server platform 110 or some other overseeing entity. For example, such a rewards pool may include tokens generated by mining blocks, tokens received via community contributions, and the like. The rewards pool tokens may be distributed in a similar way as described above for step 523.

In some embodiments, the reward amount for each contributing user may be a percentage of the submission fee/bounty paid by the submitter of the proposal or query. These rewards may encourage reviewers and raters to curate proposals and queries, lock/stake creative credits on their reviews or evaluations, and thereby contribute to a reliable ranking of proposals and responses to queries. As discussed elsewhere herein, users may have the option to lock/stake creative credits (tokens) in connection with their evaluation or review. By locking creative credits, users may add credibility to their evaluation or review and indicate to the network that their contribution is less likely to be spam. Users who lock creative credits when they make an evaluation or review accordingly may have a greater influence over the selection of proposals or resolution of a query. At the end of the selection period or query review period, the user's locked creative credits may be returned to the User.

In some embodiments, the rewards may be calculated based on: (i) accuracy (e.g., alignment with the final result and real-world data where possible); (ii) number of locked creative credits; (iii) confidence (e.g., the percentage of the User's total creative credit holdings locked on the item); and/or (iv) timing (e.g., the earlier the user acts, the higher their timing score).

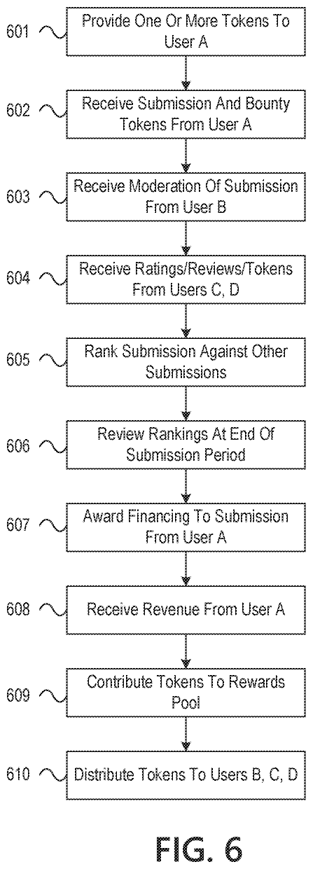

FIG. 6 illustrates an example method of carrying out the techniques described herein. The method of FIG. 6 may be executed by a server platform 110 and/or any of the devices illustrated in FIGS. 1A-B. In step 601, a first user (User A) may first need to acquire creative credits (e.g., tokens) prior to submission of a proposal (e.g., a film proposal) via the client application 121. The User A may do so by earning creative credits in via the CPA app (e.g., as described elsewhere herein), mining creative credits, purchasing creative credits, or receiving creative credits through a program that provides creative credit grants to potential submitters (e.g., film students who wish to submit their film proposals) to the client application 121. Accordingly, in step 602, the server platform 110 and/or some other device may provide one or more tokens to the user based on the user earning the tokens in any of the ways described herein.

The User A may next compile the submission materials together with an amount of creative credits (e.g., tokens) in payment of the submission fee to a smart contract. Thus, at step 602, the smart contract (and/or the server platform 110) may receive the submission and one or more bounty tokens from the user A. The submission fee (and creative credits that may be added by other users to support the submission, as described elsewhere herein) may act as a bounty of creative credits for purposes of rewarding curators (e.g., Users B. C. D), who vet, review, and rate User A's submission.

Before the submission becomes publicly available in the client application 121, it may be screened by a moderator (e.g., User B), who may vet the submission to ensure that it is compliant with the rules of the client application 121. In one example, User B (e.g., an amateur screenwriter) may be saving up creative credits to make a submission, and thus may moderate film submissions in the client application 121 to earn extra creative credits.

In embodiments, the server platform 110 (and/or some other device) may cause the submission from User A to be queued User B's inbox, where User B may review the materials as a moderator for compliance with the client application 121 guidelines. After determining that User A's submission is legitimate and does not violate any client application 121 rules, User B may approve the submission for public release via the client application 121. Accordingly, in step 603, the server platform 110 may receive a moderation from User B approving the submission.

In one example, a User C may be a film critic who attracts readership by reviewing submissions in the client application 121. User C may earn creative credits for reviewing submissions and may use the earned credits to push reviews written by User C to the top of a feed of reviews and thereby increase the influence of the reviews. Additionally or alternatively, in this example User D may be a comic who writes sketch comedy bits for television programs and spends some of her spare time earning creative credits by evaluating comedy film submissions in the client application 121. User C may use her creative credits to reward other users for reading some of her comedy bits and providing helpful feedback through the Creative Query feature of the client application 121. Users C and D may both come across User A's submission and spend time reviewing and rating it. They may both view User A's submission as reminiscent of the early Monty Python era. They therefore may rate it highly and they may choose to augment the bounty for User A's submission by adding creative credits of their own to it. That, together with the positive reviews of other Users, may propel the submission forward in the client application 121 app rankings.

Accordingly, at steps 604 and 605, the server platform 110 (and/or any other device) may receive ratings, reviews, and/or tokens from other users (e.g., Users C and D), and may rank the submission received from User A as against other submissions based at least in part on the received ratings, reviews, and/or tokens.

In this example, User A's submission may eventually make it to the top of the submission rankings. Then, when a film submission period draws to a close and it comes time to select a submission to receive a financing reward, the rankings may be reviewed (e.g., to confirm that there has been no fraud or gamesmanship). In this example, it may be determined that User A's submission is rightfully ranked first and deserving of financing. Accordingly, in step 606, the server platform 110 and/or any other device may review the rankings at the end of the submission period.

User A may then be awarded with financing (e.g., from a film fund established to provide funding, from other users or investors, etc.), which User A may use to produce the submitted screenplay into a feature length film. In some embodiments, industry partner support and opportunities may be provided to User A to aid in shepherding the project through development, production, and distribution. Accordingly, at step 607, the server platform 110 and/or any other device may award financing to the submitter of the proposal (in this case, User A).

In some embodiments, the financiers of User A's project (e.g., the film fund established to provide funding, other users or investors, etc.), may then be entitled to receive a portion of the net revenue from the film, and this net revenue may be used for various purposes (e.g., the film fund may use it to finance additional submissions). Accordingly, at step 608, the server platform 110 and/or any other device described herein may receive revenue (e.g., proceeds from the completed project specified in the submission).

Next, revenues from User A's project (e.g., the film) may be used to purchase creative credits for a rewards pool that may be distributed to various users for their achievements and contributions in the client application 121. Accordingly, the server platform 110 and/or some other device may contribute credits (e.g., tokens) to a rewards pool. Additionally or alternatively, in some cases other organizations, individuals, and businesses may provide charitable grants and donations to a rewards pool, film fund, or any other funding entity described herein.

Finally, tokens may be distributed to various users (e.g., Users B, C, D) for their various contributions from the rewards pool. In this example, therefore, in addition to the creative credits Users B, C, and D earned from the submission bounty by reviewing User A's proposal, another smart contract may distribute them creative credits from the rewards pool in proportion to their contributions (e.g., for writing a popular review).

The data transferred to and from various computing devices in the system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in the system 100 in front of one or more computing devices such that any external devices may communicate directly with the specialized hardware.

In embodiments, the server platform 110 may include one or more processor(s) for controlling overall operation of the server platform 110 and its associated components, including RAM, ROM, input/output devices(s), network interface(s), and/or memory. A data bus may interconnect the processor(s), RAM, ROM, memory, I/O device(s), and/or network interface(s). In some embodiments, the server platform 110 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Software may be stored within the memory of the server platform 110 to provide instructions to the processor(s) to allow the server platform 110 to perform various actions. For example, the memory may store software used by the server platform 110, such as an operating system, software for providing data to client devices, and/or machine learning software, and an associated internal database. The various hardware memory units in the memory may include volatile and nonvolatile, removable and non-removable media implemented in any method or technology for storage of information such as computer-readable instructions, data structures, program modules, or other data. The memory may include one or more physical persistent memory devices and/or one or more non-persistent memory devices. The memory may include, but is not limited to, random access memory (RAM), read only memory (ROM), electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by the processor(s).

The network interface(s) of the server platform 110 may include one or more transceivers, digital signal processors, and/or additional circuitry and software for communicating via any network, wired or wireless, using any protocol as described herein.

The processor(s) of the server platform 110 may include a single central processing unit (CPU), which may be a single-core or multi-core processor, or may include multiple CPUs. The processor(s) and associated components may allow the server platform 110 to execute a series of computer-readable instructions to perform some or all of the processes described herein. Although not shown in FIG. 1, various elements within the server platform 110 may include one or more caches, for example, CPU caches used by the processor(s), page caches used by the operating system, disk caches of a hard drive, and/or database caches used to cache content from a database. For embodiments including a CPU cache, the CPU cache may be used by one or more processors to reduce memory latency and access time. A processor may retrieve data from or write data to the CPU cache rather than reading/writing to memory, which may improve the speed of these operations. In some examples, a database cache may be created in which certain data from a database is cached in a separate smaller database in a memory separate from the database, such as in RAM or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of the server platform 110 are described separately, functionality of the various components may be combined and/or performed by a single component and/or multiple computing devices in communication without departing from the invention.

The client devices 120, the third party data service(s) 130, and the blockchain nodes 180 may have similar or different architecture as described with respect to the server platform 110. Those of skill in the art will appreciate that the functionality of the server platform 110 (or the client devices 120, the third party data service(s) 130, or the blockchain nodes 180) as described herein may be spread across multiple data processing devices, for example, to distribute processing load across multiple computers, to segregate transactions based on geographic location, user access level, quality of service (QoS), etc. For example, the server platform 110, client devices 120, the third party data service(s) 130, the blockchain nodes 180, and/or other devices (not shown) may operate in concert to provide parallel computing features in support of the operation of any software, methods, and/or techniques described herein.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like, that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method comprising:
receiving, from a device in communication with a blockchain, a content proposal stored on the blockchain;
providing, to a plurality of user devices, the content proposal;
receiving, from the device, information indicating;
a user rating generated by a first user device of the plurality of user devices and stored on the blockchain via a smart contract associated with the content proposal; and
a stake comprising one or more blockchain credits associated with the user rating; and
ranking a plurality of content proposals comprising the content proposal, wherein a rank of the content proposal is based on the user rating and the stake for the user rating.

2. The method of claim 1, wherein the content proposal comprises one or more of:
at least one cryptographic hash of content that is not stored on the blockchain, wherein the at least one cryptographic hash associates the content proposal with the content; or
content stored on the blockchain.

3. The method of claim 1, wherein the content proposal further comprises a bounty, wherein a second smart contract is configured to distribute at least a portion of the bounty to the first user device in exchange for the user rating.

4. The method of claim 1, wherein the user rating comprises one or more sub-ratings.

5. The method of claim 1, wherein the rank of the content proposal is further based on a reputation score associated with the user rating.

6. The method of claim 1, further comprising receiving a review of the user rating, wherein the rank of the content proposal is based on the received review of the user rating.

7. The method of claim 1, further comprising:
receiving a review of the content proposal from a second user device;
receiving one or more likes and one or more dislikes of the review; and
ranking the review of the content proposal based on the one or more likes and one or more dislikes of the review,
wherein the rank of the content proposal is based on the rank of the review.

8. A system comprising:
a server platform; and
a user device storing an application configured to perform steps comprising:
generating a content proposal comprising one or more of textual information, video information, or image information;
causing generation of a block on a blockchain comprising:
data representing the content proposal; and
a transfer of one or more tokens associated with the content proposal to a smart contract;
wherein the server platform is configured to perform steps comprising:
receiving, from a blockchain node, the content proposal;
providing, to a plurality of user devices, the content proposal;
receiving, from the blockchain node, information indicating:
a user rating stored on the blockchain via a second smart contract associated with the content proposal; and
a stake comprising one or more blockchain credits associated with the user rating; and
ranking a plurality of content proposals comprising the content proposal,
wherein a rank of the content proposal is based on the user rating and the stake for the user rating.

9. The system of claim 8, wherein the content proposal comprises one or more of:
at least one cryptographic hash of content that is not stored on the blockchain, wherein the at least one cryptographic hash associates the content proposal with the content; or
content stored on the blockchain.

10. The system of claim 8, wherein the content proposal further comprises a bounty, wherein the smart contract is configured to distribute at least a portion of the bounty in exchange for the user rating.

11. The system of claim 8, wherein the user rating comprises one or more sub-ratings.

12. The system of claim 8, wherein the rank of the content proposal is further based on a reputation score associated with the user rating.

13. The system of claim 8, wherein the server platform is further configured to perform steps comprising receiving a review of the user rating, wherein the rank of the content proposal is based on the received review of the user rating.

14. The system of claim 8, wherein the server platform is further configured to perform steps comprising:
receiving a review of the content proposal from a second user device;
receiving one or more likes and one or more dislikes of the review; and
ranking the review of the content proposal based on the one or more likes and one or more dislikes of the review,
wherein the rank of the content proposal is based on the rank of the review.

15. A method comprising:
generating, by a user device, a content proposal comprising one or more of textual information, video information, or image information;
causing, by the user device, generation of a blockchain block comprising:
data representing the content proposal; and
a transfer of one or more tokens associated with the content proposal to a smart contract;
receiving, by the user device, from a server platform, information indicating:
at least one user rating of the content proposal; and
for each of the least one user ratings, a corresponding stake comprising one or more tokens associated with the user rating; and
receiving, by the user device, a list of ranked content proposals comprising the content proposal, wherein a rank of the content proposal is based on the at least one user rating and the corresponding stake for each of the at least one user ratings.

16. The method of claim 15, further comprising:
receiving, from the server platform, a reputation score for a user of the user device, wherein the reputation score is based on the rank of the content proposal; and
displaying, by the user device, the reputation score.

17. The method of claim 15, further comprising, prior to the generating of the content proposal, receiving, by the user device, a plurality of tokens in exchange for answering a creative query.

18. The method of claim 15, further comprising:
receiving, from the server platform, an indication that another user has added tokens to the content proposal.

19. The method of claim 15, wherein the user rating comprises one or more sub-ratings.

20. The method of claim 15, wherein the rank of the content proposal is further based on a reputation score associated with the user rating.
